(19) United States
(12) Patent Application Publication
(10) Pub. No.: US 2018/0083296 A1
(43) Pub. Date: Mar. 22, 2018

(54) POROUS SEPARATOR PLATE FOR FUEL CELL AND UNIT FUEL CELL HAVING THE SAME

(71) Applicant: Hyundai Motor Company, Seoul (KR)

(72) Inventor: Jong Sung Kim, Hwaseong (KR)

(21) Appl. No.: 15/364,292

(22) Filed: Nov. 30, 2016

(30) Foreign Application Priority Data
Sep. 21, 2016 (KR) 10-2016-0120683

(51) Int. Cl. H01M 8/0258; H01M 8/023; H01M 8/1018; H01M 8/04291; H01M 8/0276

(52) U.S. Cl. CPC H01M 8/0258; H01M 8/023; H01M 2250/20; H01M 8/04291; H01M 8/0276; H01M 8/1018

(57) ABSTRACT

A porous separator plate for a fuel cell has porous flow paths, where the porous separator plate includes an inlet manifold provided at one side of the separator plate to allow reaction gas to flow therein, an outlet manifold provided at the other side of the separator plate to allow reaction gas to be drained, and an extension portion provided at a lower side of the separator plate in a direction of gravity such that water produced in the separator plate is gathered therein when the separator plate is fastened to a unit fuel cell.

### CROSS REFERENCE TO RELATED APPLICATION

The present application claims under 35 U.S.C. § 119(a) the benefit of Korean Patent Application No. 10-2016-0120683 filed on Sep. 21, 2016, the entire contents of which are incorporated by reference herein.

### BACKGROUND

(a) Technical Field

The present disclosure relates to a porous separator plate for a fuel cell, which is capable of preventing both a flooding phenomenon and a dry phenomenon that may occur in a unit fuel cell including the porous separator plate.

(b) Description of the Related Art

A fuel cell stack installed in a fuel cell vehicle includes a plurality of unit fuel cells stacked together, and represents a device that generates electricity while generating water through electrochemical reaction of hydrogen and oxygen.

A membrane electrode assembly (MEA) is placed in an innermost position of each of the unit fuel cells of the fuel cell stack. The membrane electrode assembly is composed of a structure in which catalyst layers for anode and cathode electrodes are applied respectively on opposite surfaces of a polymer electrolyte membrane.

Further, gas diffusion layers (GDLs) are placed respectively on outer portions of the membrane electrode assembly, i.e., the outer portions of the catalyst layers. In addition, placed on the outer gas diffusion layers respectively are separator plates in which channeled flow paths for supplying fuel and discharging water produced by reaction are formed respectively.

As mentioned above, the unit fuel cell of the fuel cell essentially includes a membrane electrode assembly, two gas diffusion layers and two separator plates, where a fuel cell stack of a desired size can be configured by stacking several tens to several hundreds of such unit fuel cells. In the fuel cell stack configured in the desired manner, fuel is supplied to the channeled flow path through a manifold of the separator plate and then supplied to the membrane electrode assembly via the gas diffusion layer, with the result that electricity is produced through electrochemical reaction, and at the same time water and vapor produced during generation of electricity are discharged to the outside.

Recently, however, research has focused on a porous separator plate having a plurality of flow passage holes that can replace such a typical separator plate. A separator plate shown in FIG. 1 (RELATED ART) is a porous separator plate according to the related art. Using a porous separator plate is advantageous in that it is possible to give turbulent flow to reaction gas passing through the separator plate, obtain an effect that workability of the separator plate is excellent because its shape is simplified compared to the existing typical separator plate, and increase an amount of diffusion of a reaction gas to the gas diffusion layer.

On the other hand, as previously mentioned, water is produced naturally in the inside of the fuel cell stack by electrochemical reaction in the process of generating electricity. If such water cannot be drained to the outside of the stack and remains in the inside of the stack, this becomes a factor obstructing generation of electricity of the fuel cell, which may produce a flooding phenomenon. Further, on the contrary, if the water is excessively drained, the fuel cell stack becomes dry, thereby deteriorating durability of the fuel cell. Therefore, it is a core technology in the field of fuel cells that humidity in the fuel cell stack can be maintained suitably by utilizing the water produced in the fuel cell stack appropriately.

As the foregoing described as the background art is just to promote better understanding of the background of the present disclosure, it must not be taken as an admission that it corresponds to the related art well known to those who have ordinary skill in the art.

### SUMMARY

It is an object of the present disclosure to provide a porous separator plate for a fuel cell that allows the water produced by electrochemical reaction within a fuel cell stack to be stored temporarily in a space rather than a reaction surface of the fuel cell stack so that a flooding phenomenon of the fuel cell stack can be prevented, and it is possible to humidify the fuel cell stack by means of the stored water as necessary.

A porous separator plate for a fuel cell according to the present disclosure for accomplishing the object as mentioned above includes an inlet manifold provided at one side of the separator plate to allow reaction gas to flow therein, an outlet manifold provided at the other side of the separator plate to allow the reaction gas to be drained, and an extension portion extended from the separator plate in a direction of gravity such that water produced in the separator plate is stored therein when the separator plate is fastened to a unit fuel cell.

The inlet manifold can be provided at a position higher than a position of the outlet manifold.

The inlet and outlet manifolds are provided on left and right sides of the separator plate respectively and the extension portion may be formed at a lower side end of the separator plate.

The extension portion may be formed with a bead so as to protrude from the separator plate.

A plurality of beads arranged along a flow direction of the reaction gas flowing on the separator plate.

The bead may protrude in a direction in which the separator plate is stacked.

In a unit fuel cell including a porous separator plate for a fuel cell according to the present disclosure, a gasket is coupled along a border of the separator plate, where the gasket is extended along the border of the extension portion to form a closed loop which covers the separator plate and the extension portion.

The unit fuel cell may further include a sub-gasket which is formed in a panel shape covering the separator plate and the extension portion and constitutes a water tank for storing the byproduct water along with the extension portion and the gasket when it is coupled to the separator plate.

Another porous separator plate for a fuel cell having porous flow paths and being attached to a cathode side of the fuel cell, according to the present disclosure, includes an inlet manifold provided at one side of the separator plate to allow reaction gas to flow therein, an outlet manifold provided at the other side of the separator plate to allow the reaction gas to be drained, and an extension portion extended from the separator plate in a direction of gravity such that the water produced in the separator plate is stored therein when the separator plate is fastened to a unit fuel cell.

According to the present disclosure, water gathered in the lower portion of the separator plate flows into the water tank so that flooding phenomenon is prevented. Further, when the fuel cell stack becomes dry, the water stored in the water tank is evaporated by temperature of the separator plate heated to high temperature and thus vapor generated thereby humidifies the unit fuel cell so that a dry phenomenon is prevented.

### BRIEF DESCRIPTION OF THE DRAWINGS

FIG. 1 (RELATED ART) is a view illustrating a porous separator plate for a fuel cell according to the related art.

FIG. 2 is a view illustrating a porous separator plate for a fuel cell according to an embodiment of the present disclosure.

FIG. 3A is a view of a porous separator plate for a fuel cell having a water tank to which beads are added.

FIG. 3B is a cross-sectional view of the porous separator plate of FIG. 3A.

FIG. 4 is an exploded perspective view of a unit fuel cell according to an embodiment of the present disclosure.

### DESCRIPTION OF SPECIFIC EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Preferred embodiments of the present disclosure will now be described in detail with reference to the accompanying drawings. However, the present disclosure is not limited or restricted by the preferred embodiments.

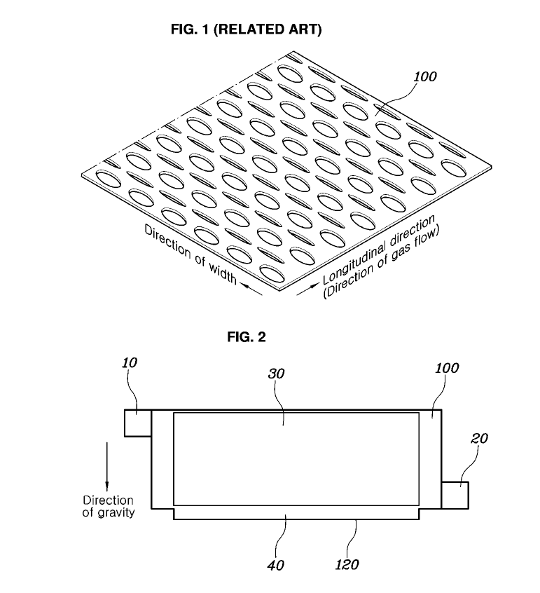

Prior to discussing the present disclosure specifically, reference is made to a porous separator plate 100 on the assumption that the present disclosure will be applied thereto. The porous separator plate may have a variety of forms, but typically has a configuration shown in FIG. 1. According to such configuration, reaction gas (e.g., hydrogen or air) does not flow along a direction of a flow path, but along holes perpendicular to the flow path so that diffusion power of the reaction gas passing to through the holes becomes stronger than that occurring in the conventional separator plate, thereby enhancing reaction efficiency of the fuel cell.

In case of such a porous separator plate, however, water produced by electrochemical reaction in the fuel cell does not move along discontinuous flow paths, but flows down by its weight to the lowermost side of the separator plate unlike the typical separator plate in which reaction gas is supplied through a series of uninterrupted and continuous flow paths, and thus a phenomenon that the water is gathered is bound to occur.

Of course, although most of the byproduct water will be drained to the outside of the fuel cell stack by the strengthened diffusion power of the reaction gas, there is a possibility that it cannot be drained and hence remains in the inside of the fuel cell stack. Further, the remaining water may be frozen when a temperature of the fuel cell stack drops sufficiently and thereby flow of the reaction gas is interrupted, with the result that efficiency of power generation of the fuel cell is deteriorated and durability of the fuel cell is adversely affected. Therefore, as to the porous separator plate, it is a problem in the field of fuel cells utilizing the porous separator plate as to how to treat the byproduct water accumulated in the lower side of the separator plate according to operation of the fuel cell.

In the present disclosure, in order to prevent performance and durability of the fuel cell from being deteriorated due to the byproduct water, a separator plate 100 for a fuel cell including porous flow paths 30 as illustrated in FIG. 2 includes an inlet manifold 10 provided at one side of the separator plate 100 to allow reaction gas to flow therein, an outlet manifold 20 provided at the other side of the separator plate 100 to allow reaction gas to be drained, and an extension portion 40 extended downward of the separator plate 100 in a direction of gravity such that the water produced in the separator plate 100 is gathered therein when the separator plate 100 is fastened to a unit fuel cell.

The inlet manifold 10 and the outlet manifold 20 are portions through which reaction gas, i.e., air or hydrogen is introduced and discharged respectively and provided respectively on one side and the other side of the separator plate 100. In the porous separator plate 100 as shown in FIG. 2, since a direction of the porous flow paths 30 corresponding to a direction from the top side to the lower side of the separator plate 100 is the same as a direction of gravity, the inlet manifold 10 and the outlet manifold 20 through which the reaction gas flowing in a direction perpendicular to the direction of the flow paths is introduced and drained respectively are preferably provided on the left and right sides of the separator plate 100 respectively in terms of fluidity of the reaction gas. In particular, the inlet manifold 10 and the outlet manifold 20 are configured in such a manner that holes formed in the separator plates 100 are piled one upon another by stacking a plurality of separator plates 100, and hence a series of flow paths are formed.

In addition, according to the present disclosure, the inlet manifold 10 may be provided at a position higher than a position of the outlet manifold 20 in a direction of gravity as illustrated in FIG. 2. This is to allow water produced by the reaction gas introduced through the inlet manifold 10 to smoothly flow down into the extension portion 40 provided at the lower side of the separator plate 100 with the aid of gravity.

Accordingly, water produced in the porous flow paths 30 in the process of power generation of the fuel cell drops toward the lower side of the separator plate 100 due to the effect of gravity, and then the water fallen flows into the extension portion 40 provided at the lower side of the separator plate 100 and is gathered in the water tank formed by the extension portion 40. Therefore, since the byproduct water does not gather in the inside of the separator plate 100, a flooding phenomenon can be fundamentally blocked.

Further, according to the structure of the separator plate 100 of the present disclosure, when a temperature of the fuel cell is elevated to a high temperature and hence the inside of the fuel cell stack becomes dry, the byproduct water stored in the water tank is evaporated by heat conducted to the extension portion 40 by the high temperature of the separator plate 100 and then the vapor rises and is supplied to the separator plate 100 so that the degree of deteriorating durability of the fuel cell due to a dry phenomenon of the fuel cell stack can be reduced.

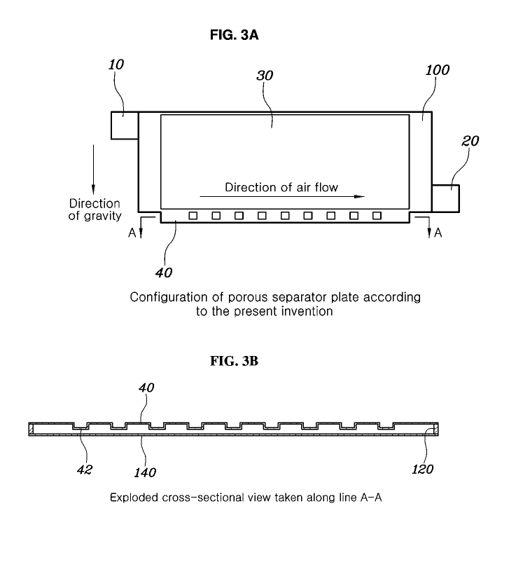

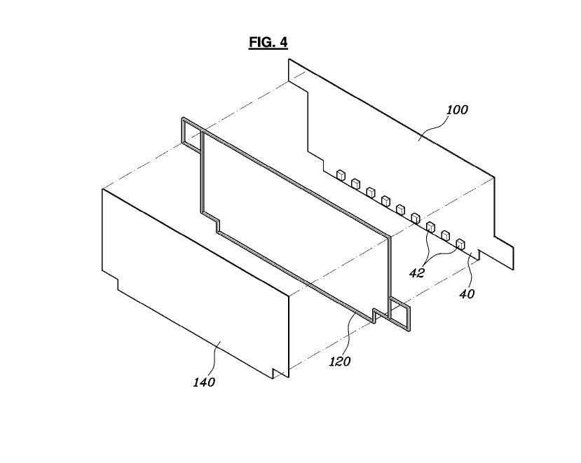

A portion where the separator plate 100 abuts on the extension portion 40 may be configured without a separate bead as shown in FIG. 2. However, it is also possible to form beads on the extension portion 40 in contact with the lower side of the separator plate 100 as shown in FIG. 3A. Shape of the beads may be produced in various shapes other than the rectangle shape as shown in FIG. 3B. In addition, the beads may be formed as a plurality of beads with a predetermined interval along a flow direction of the reaction gas flowing into the inlet manifold 10 of the separator plate 100, as shown in FIG. 3B.

The reason for forming the beads as shown in FIG. 3A and FIG. 3B despite difficulty of manufacturing thereof is that: the contact area between the extension portion 40 and the separator plate 100 can be increased by the beads, and thus the heat transfer area between the extension portion 40 and the byproduct water in the water tank can be increased so that an evaporation amount of water in the fuel cell is increased, with the result that when the fuel cell becomes dry, more water vapor can be supplied to the unit fuel cell.

Further, the beads provided on the extension portion 40 may also be formed to protrude in a direction in which the separator plate is stacked, as shown in FIG. 3B. This is because if the beads are formed in this way, flow resistance in the extension portion 40 can be increased, and thus a flow rate of air flowing into the extension portion 40 can be reduced so that the byproduct water in the extension portion 40 can be prevented from being discharged to the outlet manifold 20 due to the reaction gas at the time of flooding.

In other words, the conventional separator plate adopts a structure for discharging the byproduct water without reserve in order to prevent a flooding phenomenon because it has no space for separately storing the byproduct water even when the water is excessively produced in the process of power generation of the fuel cell, whereas the separator plate 100 according to the present disclosure is provided with the extension portion 40 capable of storing the byproduct water contrary to the conventional separator plate, and thus such a structure of the separator plate 100 can minimize discharge of the byproduct water to the outside of the fuel cell stack due to the flow of the reaction gas.

The separator plate 100 according to the present disclosure can be applied to either an anode side or a cathode side. In general, since water is produced in a greater amount in the cathode side than in the anode side, it may be contemplated to provide the extension portion 40 only in the separator plate 100 of the cathode side.

FIG. 4 shows an exploded perspective view of a unit fuel cell including a porous separator plate for a fuel cell 100 according to the present disclosure.

In case of the unit fuel cell shown in FIG. 4, a gasket 120 is attached along a border of the separator plate 100, where the gasket 120 is extended along the border of the extension portion 40 to form a closed loop which covers the separator plate 100 and the extension portion 40.

Further, a sub-gasket 140 is formed in a panel shape covering the separator plate 100 and the extension portion 40 and constitutes a water tank for storing the byproduct water along with the extension portion 40 and the gasket 120 when it is coupled to the separator plate 100. Therefore, a flooding phenomenon is prevented because the byproduct water is stored in the water tank, and a dry phenomenon is prevented because the byproduct water can be evaporated later. FIG. 3A shows a front view of the separator plate without the sub-gasket and FIG. 3B shows a condition that the sub-gasket 140 is coupled. Further, FIG. 4 shows a perspective view of the sub-gasket 140.

On the other hand, the unit fuel cell according to the disclosure also has a structure in which a membrane electrode assembly, gas diffusion layers and separator plates are joined together like the conventional unit fuel cell. However, the separator plate 100 according to the present disclosure includes the extension portion 40 allowing the byproduct water falling by gravity to be gathered in the lower side of the separator plate. In this case, it may be contemplated that the gas diffusion layer 300 or the membrane electrode assembly 200 is arranged not to contact with the lower side of the separator plate 100, at which the extension portion 40 is provided. The reason is that since the extension portion 40 is provided only to store the byproduct water, it is not necessary to extend the gas diffusion layer or the membrane electrode assembly to a face on which the extension portion 40 is provided. Therefore, the structure of the unit fuel cell proposed in the present disclosure can be completed by replacing the conventional separator plate with the separator plate 100 according to the present disclosure, which includes the extension portion 40 but utilizes the conventional membrane electrode assembly and gas diffusion layer.

In this case, however, the gasket disposed along the edge of the separator plate 100 must be disposed in such a manner that it extends along the edge of the extension portion 40 from the lower side of the separator plate 100 and forms a closed loop because air tightness of the unit fuel cell must be maintained. Even if the porous separator plate 100 including the extension portion 40 according to the present disclosure as previously mentioned is applied only to the cathode side, air tightness of the unit fuel cell must be maintained. Therefore, an additional configuration having the same outer shape as the extension portion 40 is also required in another separator plate 100 on the anode side and another gasket for the separator plate 100 on the anode side is also disposed in the same manner as the gasket on the cathode side such that it extends along the edge of a configuration added to the lower side of the anode side separator plate 100 and forms a closed loop.

Although the present disclosure has been described and illustrated with respect to specific embodiments, it will be apparent by those who have ordinary skill in the art that various modifications and changes to the present disclosure may be made without departing from the spirit and scope of the present disclosure as defined in the appended patent claims.

What is claimed is:

1. A porous separator plate for a fuel cell having porous flow paths, the separator plate comprising:
an inlet manifold provided at one side of the separator plate to allow reaction gas to flow therein,
an outlet manifold provided at the other side of the separator plate to allow the reaction gas to be drained, and
an extension portion extended from the separator plate in a direction of gravity such that water produced in the separator plate is stored therein when the separator plate is fastened to a unit fuel cell.

2. The porous separator plate for a fuel cell of claim 1, wherein the inlet manifold is provided at a position higher than a position of the outlet manifold.

3. The porous separator plate for a fuel cell of claim 1, wherein the inlet and outlet manifolds are provided on left and right sides of the separator plate respectively, and the extension portion is formed at a lower side end of the separator plate.

4. The porous separator plate for a fuel cell of claim 1, wherein the extension portion is formed with a bead so as to protrude from the separator plate.

5. The porous separator plate for a fuel cell of claim 4, wherein a plurality of beads are arranged along a flow direction of the reaction gas flowing on the separator plate.

6. The porous separator plate for a fuel cell of claim 3, wherein the bead protrudes in a direction in which the separator plate is stacked.

7. A unit fuel cell comprising a porous separator plate for a fuel cell according to claim 1, wherein a gasket is attached along a border of the separator plate, and wherein the gasket is extended along the border of the extension portion to form a closed loop which covers the separator plate and the extension portion.

8. The unit fuel cell of claim 7 further comprising a sub-gasket which is formed in a panel shape covering the separator plate and the extension portion and constitutes a water tank for storing water to be produced along with the extension portion and the gasket when it is coupled to the separator plate.

9. A porous separator plate for a fuel cell having porous flow paths and being attached to a cathode side of the fuel cell, the separator plate comprising:
an inlet manifold provided at one side of the separator plate to allow reaction gas to flow therein,
an outlet manifold provided at the other side of the separator plate to allow the reaction gas to be drained, and
an extension portion extended from the separator plate in a direction of gravity such that water produced in the separator plate is stored therein when the separator plate is fastened to a unit fuel cell.
